(19) United States
(12) Patent Application Publication
(10) Pub. No.: US 2018/0250654 A1
(43) Pub. Date: Sep. 6, 2018

(54) CALCINATION OF CO2/H2O DISPLACEMENT DESORPTION SORBENTS

(71) Applicants: ExxonMobil Research and Engineering Company, Annandale, NJ (US); TDA Research, Inc., Wheat Ridge, CO (US)

(72) Inventors: Chuansheng Bai, Phillipsburg, NJ (US); Majosefina Cunningham, Whitehall, PA (US); Patrick P. McCall, Matawan, NJ (US); Hans Thomann, Bedminster, NJ (US); Jeannine Elizabeth Elliott, Superior, CO (US); Vinh Nguyen, Arvada, CO (US)

(21) Appl. No.: 15/910,257

(22) Filed: Mar. 2, 2018

Related U.S. Application Data
(60) Provisional application No. 62/466,833, filed on Mar. 3, 2017.

(51) Int. Cl. B01J 20/04; B01J 20/08; B01J 20/30; B01J 20/32; B01J 20/34; B01D 53/02

(52) U.S. Cl. CPC B01J 20/041; B01J 20/08; B01J 20/3007; B01J 20/3078; B01J 20/3204; B01J 20/3236; B01D 2259/40083; B01J 20/3433; B01D 53/02; B01D 2253/1124; B01D 2253/25; B01D 2257/504; B01J 20/3466

(57) ABSTRACT

The disclosure generally relates to CCS sorbents, particularly for CO₂/H₂O displacement desorption process. The sorbent includes an aluminum oxide support and an alkali metal salt impregnated on the support. The support can be prepared by creating and extruding a dough to create an extrudate, which is then drying and calcined to form the support. Calcination temperatures can be between about 120° C. and 500° C., preferably about 200° C. to about 400° C. The sorbents demonstrate improved CO₂ loadings and better H₂O/CO₂ ratios, as well as improved stability. Compositions and methods of making are disclosed.

### CROSS REFERENCE TO RELATED APPLICATIONS

This application claims the benefit of U.S. Provisional Patent Application No. 62/466,833, filed 3 Mar. 2017, which is entirely incorporated herein by reference.

### STATEMENT REGARDING FEDERALLY SPONSORED RESEARCH

Portions of this disclosure were made with government support under Contract No. DE-FE0012870, awarded by the Department of Energy. The government may have certain rights in the invention.

### TECHNICAL FIELD

The various embodiments of the disclosure relate generally to methods for preparing and compositions contained alkali metal salt aluminum oxide compositions, and calcination of the same. It is particularly useful for improved performance in CO₂/H₂O displacement desorption systems.

### BACKGROUND

Fossil fuels currently supply the majority of world's energy needs and their combustion is the largest source of anthropogenic carbon dioxide emissions. Carbon dioxide is a greenhouse gas and is believed to contribute to global climate change. Concern over global climate warming has led to interest in capturing CO₂ emissions from the combustion of fossil fuels. The quantities of combustion gas produced in electric power generation are large because of the scale of furnaces and turbines utilized. One measure of the scale of these operations is the amount of CO₂ produced in a typical 500 Megawatt power plant, for coal fired power generation, the rate of CO₂ production is on the order of 100 kg per second; for gas fired power production it is more like 50 kg per second.

CO₂ can be removed from combustion flue gas streams by various methods, often referred to a carbon capture and sequestration (CCS.) The challenge for CO₂ capture from flue gas is to do it efficiently to minimize the cost. All post-combustion CO₂ capture technologies suffer from the disadvantages that the CO₂ in the flue gas is present at low pressure (1 atmospheric pressure) and in low concentrations (3 to 15%). A large amount of energy is needed to separate CO₂. Developing methods that minimize the amount of energy and other costs will be necessary if CO₂ removal from flue gas is to be economical. Methods for the removal of CO₂ from flue gas streams include adsorption with a solvent, adsorption with a sorbent, membrane separation, and cryogenic fractionation and combinations thereof. In absorption/adsorption processes to capture CO_{2,} the energy needed to regenerate the sorbent or solvent is also a large cost element.

CO₂ displacement desorption process uses a competitive adsorption of H₂O to drive off adsorbed CO₂ on sorbent. During CO₂ capturing step, CO₂ of the flue gas displaces the adsorbed H₂O on the sorbent. Displacement desorption swings the concentrations of H₂O and CO₂. It is an isothermal process and has no need for pressure swing.

### BRIEF SUMMARY

The various embodiments of the disclosure relate generally to methods for preparing CCS sorbent, particularly CO₂/H₂O displacement desorption sorbent.

An embodiment of the disclosure can be a method for preparing a CCS sorbent, comprising preparing a support by mixing an aluminum compound to form a dough, extruding the dough to form an extrudate, drying the extrudate to form the support; and calcining the support at about 120 to about 500° C. for at least 1 hour. The support can then be impregnated with an alkali metal salt into the support, the impregnated support can be dried, and the impregnated support can be calcined at about 400 to about 550° C. for at least 3 hours to create the sorbent.

In some embodiments of the disclosure, the extrudate can be dried at between about 90 and about 175° C. In some embodiments of the disclosure, the extrudate can be calcined between about 250 to about 400° C., or the extrudate can be calcined between about 250 to about 350° C.

In some embodiments of the disclosure, the aluminum compound can be aluminum oxide, aluminum oxide hydroxide, aluminum hydroxide, boehmite, or pseudoboehmite; or the aluminum compound can be an aluminum oxide hydroxide, boehmite or pseudoboehmite.

In some embodiments of the disclosure, the impregnating alkali metal salt can be a potassium salt, a sodium salt, or a lithium salt. In some embodiments of the disclosure, the impregnating alkali metal salt can be potassium and sodium.

In some embodiments of the disclosure, the impregnating alkali metal salt can be greater than about 5 weight % of the sorbent as M₂O, or greater than 7 wt %, or greater than 8 wt %.

In some embodiments of the disclosure, the mixing of the aluminum compound can further include an alkali metal salt in a mixture with the aluminum compound to form the dough. The alkali metal salt added to the mixture comprises a potassium salt, a sodium salt, or both a potassium salt and a sodium salt.

An embodiment of the disclosure can be a method for preparing a CCS sorbent, comprising calcining a dried aluminum compound extrudate at about 125 to about 500° C. for at least 1 hour to create a support, and calcining the support at about 400 to about 550° C. for at least 3 hours after impregnating with an alkali metal salt.

In some embodiments of the disclosure, the extrudate can be calcined between about 250 to about 400° C. In some embodiments, the extrudate can be calcined between about 250 to about 350° C.

In some embodiments of the disclosure, the support can be calcined between about 450 and 550° C.

In some embodiments of the disclosure, the aluminum compound can be aluminum oxide, aluminum oxide hydroxide, aluminum hydroxide, boehmite, or pseudoboehmite. In some embodiments, the aluminum compound can be aluminum oxide hydroxide, boehmite or pseudoboehmite.

In some embodiments of the disclosure, the impregnating alkali metal salt can be a potassium salt, a sodium salt, or a lithium salt. The impregnating alkali metal salt can be potassium and sodium. In some embodiments of the disclosure, the impregnating alkali metal salt can be about greater than about 5 weight % of the sorbent as M₂O, or about 6 weight %, or about 8 weight % of the sorbent as M₂O.

In some embodiments of the disclosure, the mixing of the aluminum compound can further include an alkali metal salt in a mixture with the aluminum compound to form the dough. The alkali metal salt added to the mixture comprises a potassium salt, a sodium salt, or both a potassium salt and a sodium salt.

### BRIEF DESCRIPTION OF THE DRAWINGS

FIG. 1 illustrates a simplified system of CO₂/H₂O displacement desorption system in which a sorbent of the disclosure would be applied, in accordance with an exemplary embodiment of the disclosure.

FIG. 2 illustrates CO₂ sorption on a series 16% K₂O/Al₂O₃ sorbents prepared at different calcinations temperatures, in accordance with an exemplary embodiment of the disclosure.

### DETAILED DESCRIPTION

Although preferred embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

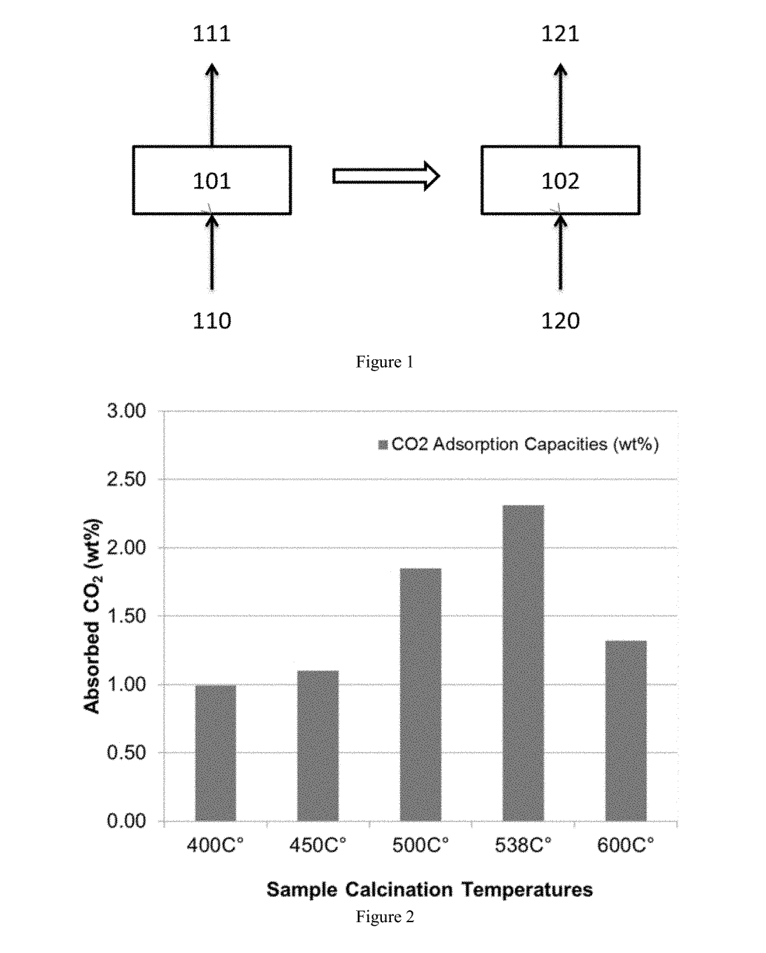

Embodiments of this disclosure include sorbent for use in a CCS process, particularly CO₂/H₂O displacement desorption, and methods for preparing or improving the stability of those sorbents. FIG. 1 demonstrates a simplified system of CO₂/H₂O displacement desorption, in which a sorbent of this disclosure might be applied. System 100 includes two sorbent bed positions, 101 and 102, in which the sorbents of this disclosure would be placed. Sorbent bed position 101 contains a sorbent that is initially CO₂ poor. A CO₂ rich stream, 110, e.g. a flue gas feed from a combustion source, passes across sorbent bed 101, which absorbs the CO_{2,} and a CO₂ depleted stream exits the bed. Once sorbent bed 101 is saturated, it can move to sorbent bed position 102. A steam feed 120 containing water vapor, can enter the CO₂ saturated sorbent bed 102 and cause desorption and displacement of the CO₂ from the sorbent. The exit gas stream is then a CO₂ rich stream that can then be further processed. Once sorbent bed 102 is regenerated, it can return to position 101. Several applications of this system have been demonstrated, such as in U.S. Pat. Nos. 9,504,955; 9,446,343; 9,539,540; and 9,527,029.

The typical sorbent used in CO₂/H₂O displacement desorption is an alkali metal salt impregnated on an aluminum oxide catalyst, particularly using a potassium salt. K₂CO₃/Al₂O₃ is a preferred sorbent. However, these sorbents deactivate on stream, which degrades performance of the system. CCS tests showed the sorbents usually had high initial CO₂ sorption capacities, but they were gradually losing CO₂ sorption capacities on stream. Sorbent aging also leads to higher H₂O/CO₂ molar ratios, which also degrades efficiencies. In the course of studying several aspects of the sorbent degradation and developing improvements on the sorbents for these processes, methods for improving the dispersion alkali metals and stability of sorbents were developed.

To improve the dispersions of alkali metal carbonates, particularly Na and K carbonates, an initial examination of extrudates was conducted that focused on of aluminum hydroxide (Versal 300 boehmite, γ-AlOOH) calcined at various temperatures (120, 200, 230, 300, 350 and 538° C.). Without wishing to be bound by theory, the alumina supports calcined at low temperatures can preserve more hydroxyl groups on alumina support, which can act as anchoring points for the dispersions of Na and K carbonates. The sorbents thus prepared showed higher CO₂ sorption capacities and low H₂O/CO₂ displacement molar ratios, compared to Na and K carbonates supported on alumina support calcined at high temperature. Na₂CO₃ and K₂CO₃ supported on low temperature calcined alumina supports showed better CCS performances compared to the sorbents made with high temperature calcined alumina support.

In addition, the degradation of alkali metal impregnated aluminum sorbents has been observed, and a question of upper boundaries of calcination was also considered. In one investigation, potassium impregnated alumina was monitored versus calcinations temperature. After impregnations of K₂CO₃, the calcinations of K₂CO₃/Al₂O₃ were carried out at 400, 450, 500, 538, and 600° C., respectively. The thermal calcination promotes K₂CO₃ dispersion on alumina support surface, which improves CO₂ sorption capacity. However, higher temperature calcination drives the formation of potassium aluminate KAlO₂, which reduces CO₂ sorption capacity. The optimum calcination temperature determined by TGA CO₂ sorption measurements is 538° C., which balances K₂CO₃ dispersion on alumina and the formation of KAlO₂.

The key technical challenges in CO₂ displacement desorption process include how to maintain the stability of a CCS sorbent, how to increase sorbent's CO₂ sorption capacity and minimize steam usage. The sorbents made by impregnations of Na₂CO₃ and K₂CO₃ on low temperature calcined alumina supports showed excellent and stable CCS performances, high CO₂ loading capacities and low CO₂/H₂O molar ratios. Stable sorbents also need less sorbent regenerations, less CCS unit downtime and less operating costs.

This disclosure includes a method for preparing a CCS sorbent, particularly CO₂/H₂O displacement desorption, including preparing a support by mixing an aluminum compound to form a dough, extruding the dough to form an extrudate, drying the extrudate to form the support; and calcining the support at about 120° C. to about 500° C. for at least 1 hour. The sorbent can then be prepared by impregnating an alkali metal salt into the support, drying the impregnated support, and calcining the impregnated support at about 400 to about 550° C. for at least 3 hours to create the sorbent.

The disclosure also includes a method for preparing the CCS sorbent by calcining a dried aluminum compound extrudate at about 125° C. to about 500° C. for at least 1 hour to create a support, and calcining the support at about 400° C. to about 550° C. for at least 3 hours after impregnating with an alkali metal salt.

As noted above the temperature at which the extrudate is calcined can allow for better control of absorption and desorption properties in the final sorbent. This step can be described as calcinations of the extrudate to form the support, or the first calcinations. The extrudate can be calcined at a temperature of about 120° C. to 500° C. The extrudate can be calcined at a temperature above about 120° C., above about 150° C., above about 175° C., above about 200° C., above about 225° C., or above about 250° C. The extrudate can be calcined at a temperature below about 500° C., below about 450° C., below about 400° C., or below about 350° C. The extrudate can be calcined at a temperature range of about 150° C. to about 500° C., about 200° C. to about 450° C., about 200° C. to about 400° C., about 250° C. to about 400° C., or about 250° C. to about 350° C. The extrudate can be calcined for at least about 1 hour, at least about 2 hours, at least about 3 hours, at least about 4 hours, or at least about 5 hours.

The support that is created by the initial calcination step can then be impregnated with an alkali metal ion, and then subsequently calcined. This step can be described as calcinations of the support to form the sorbent, or the second calcinations. The support can be calcined at a temperature of at least about 300° C., at least about 350° C., at least about 400° C., or at least about 450° C. The support can be calcined at a temperature of less than 600° C., preferably less than about 550° C. The support can be calcined between about 400° C. to about 550° C., or about 450° C. to about 550° C.

In the preparation of the extrudate to form the support, and impregnation of the support to form the sorbent, the step typically includes a solvent, usually a polar solvent and typically an aqueous solvent, which allows for mixing of the aluminum compound or distribution of the alkali metal salt. For example, impregnating an alkali metal salt onto the support is typically conducted in water, although other solvents could be used, such as an alcohol or an aprotic polar solvent. That solvent, e.g. water, is removed in a drying step that is conducted prior to calcining the sample. One of skill in the art would recognize that the solvent removal is common to creating supports of this type, and that the drying temperature is typically below the calcining temperature. However, one of ordinary skill would also understand that the steps of drying and calcining may not necessarily be formally divided, but could be part of the nature ramp-up of temperatures in preparation of the material. In the disclosure, the extrudate can be dried at a temperature at or below the calcinations temperature. In an embodiment, the extrudate can be dried at a temperature of about 90° C. to about 200° C., about 90° C. to about 175° C., about 100° C. to about 200° C., or about 125° C. to about 200° C. Similarly, the impregnated support can be dried prior to calcination to form the sorbent. The impregnated support can be dried at about 90° C. to about 200° C., about 90° C. to about 175° C., about 100° C. to about 200° C., or about 125° C. to about 200° C.

In the disclosure, the aluminum compound includes any general aluminum oxide type compound, such as one of ordinary skill in the art would use in making aluminum oxide-type support structures. In an embodiment, the aluminum compound can be comprises aluminum oxide, aluminum oxide hydroxide, aluminum hydroxide, boehmite, or pseudoboehmite. The aluminum oxides, oxide hydroxides, and hydroxides can include: aluminum oxides including γ-aluminum oxide, θ-aluminum oxide, corundum (Al₂O₃); aluminum oxide hydroxides such as diaspore (α-AlO(OH)), boehmite or böhmite (γ-AlO(OH)), akdalaite, including 5Al₂O₃.H₂O and 4Al₂O₃.H₂O), also called tohdite; and aluminum hydroxides such as gibbsite, hydrargillite (hydrargyllite), bayerite, doyleite, nordstrandite, including α-Al(OH)₃, β-Al(OH)₃, γ-Al(OH)₃. In some preferred embodiments, the aluminum compound comprises aluminum oxide hydroxide compounds, particularly, boehmite, or pseudoboehmite. While traditional Al₂O₃ compounds, as well as other aluminum oxide type compounds can work effectively, and without wishing to be bound by theory, the boehmite and pseudoboehmite compounds appear to be more effective in part because of the added hydroxylation of the alumina composition, prior to drying and optionally calcining the support/extrudate.

An embodiment of the disclosure also includes impregnating the support with an alkali metal compound. This alkali metal salt can alternatively be described as the impregnating metal salt, because it is added to the support via impregnation to form the sorbent. By alkali metal salt is meant a Group 1 metal (group IA), including lithium (Li), sodium (Na), potassium (K), rubidium (Rb), and cesium (Cs). The alkali metal salt (i.e. impregnated alkali salt) can include lithium, sodium, potassium, rubidium, or cesium, or combinations thereof. The alkali metal salt can include lithium, sodium, potassium, or cesium, or combinations thereof. The alkali metal salt can include lithium, sodium, or potassium, or combinations thereof. The alkali metal salt can include potassium or sodium. The alkali metal salt can include potassium and sodium.

In some instances, the alkali metal salt can be two different alkali metal salts. For example, impregnating both potassium and sodium can provide improved performance and stability over impregnating with only one alkali metal salt, including particularly only potassium metal salts. As discussed in a co-pending provisional application filed by the same entity on the same day, and titled MIXED METAL SORBENTS FOR CO₂/H₂O DISPLACEMENT DESORPTION, which is incorporated by reference in its entirety as if set forth herein, poisoning effects and improved performance can be achieved if two salts can be applied as the impregnating salts.

In another embodiment, the amount of alkali metal salt, or the amount of alkali metal salt added to the support via impregnation during the method of making the support, can be at least about 5 wt % of the sorbent, at least about 6 wt % of the sorbent, at least about 7 wt % of the sorbent, at least about 8 wt % of the sorbent, at least about 9 wt % of the sorbent, at least about 10 wt % of the sorbent, at least about 11 wt % of the sorbent, or at least about 12 wt % of the sorbent. The percent weight of alkali metal is presented as weight M₂O as a percentage of the total weight of the sorbent. The weight percent of M₂O is defined as the weight of M₂O/(the weight of alumina support+the weight of M₂O).

One of ordinary skill would understand that alkali metal salt in the context of this disclosure implies the alkali metal cation. As such, synonymous terms include alkali metal compound, alkali metal salt, alkali metal ion, alkali metal cation, an alkali salt, alkali ion, alkali compound, or alkali cation. The alkali metal salt can also in the context of this disclosure be referred to as an alkali metal composition.

Because the alkali metal is a cation, it will necessarily have a counterion, i.e. an anion. However, the nature of that anion is not a limiting issue. On the sorbent, particularly during operation, the anion can be a carbonate or bicarbonate counterion, or a hydroxyl or oxide anion that is part of the support to which the alkali metal is impregnated upon. Moreover, during preparation of the sorbents, and also as part of the sorbent when the salt is impregnated on the support, or when it's included as part of the extrudate, the alkali metal cation can have any counteranion one of ordinary skill would use. Nonlimiting examples of the anion can be hydroxides, halides, carbonates, bicarbonates, nitrates, nitrite, phosphate, hydrogen phosphate, dihydrogen phosphate, and organic acid salts including but not limited to acetate, citrate, gluconate, and benzoic acid, etc.

Another embodiment of the disclosure can included the addition of an alkali metal salt to the aluminum compound during mixing to form the dough. This alkali metal salt can be described as an extrudate alkali metal salt since it is contained within the extrudate that is used to make the support. As discussed in a co-pending provisional application filed by the same entity on the same day, and titled HIGH PERFORMANCE CCS SORBENTS AND METHODS OF MAKING SAME, which is incorporated by reference in its entirety as if set forth herein, an alkali metal can be introduced to the aluminum compound during mixing to form the dough, extruded, and dried and calcined to form the support. The extrudate alkali metal salt can be any alkali metal salt. The extrudate alkali metal salt can be a lithium salt, a sodium salt, a potassium salt, or combinations thereof. Preferably the alkali metal salt added to the mixture includes a potassium salt, a sodium salt, or both a potassium salt and a sodium salt.

### EXAMPLES

The following examples are illustrative, but not limiting, of the methods and compositions of the present disclosure. Other suitable modifications and adaptations of the variety of conditions and parameters normally encountered in the field, and which are obvious to those skilled in the art, are within the spirit and scope of the disclosure. All patents and publications cited herein are fully incorporated by reference herein in their entirety.

### Example 1

### 16 wt % K₂O/γ-Al₂O₃ Calcined at Various Temperatures

γ-Al₂O₃ extrudates (1/20 inch in diameter, quadlobe shape) were used as support to deposit potassium acetate. It has surface area of 250 m²/g, 0.85 cm³/g pore volume and pore size centered on 73 \acute{Å}. The aqueous solution containing potassium acetate was prepared by dissolving potassium acetate in distilled H₂O. 157.0 g of potassium acetate (CH₃COOK) was dissolved in 200.0 g of di-H₂O. The total solution volume of CH₃COOK adjusted with distilled water was 260.0 ml. 400.0 g of alumina extrudates were impregnated with the solution by incipient wetness. The sample was dried in air at 120° C. for 16 hours. Then the sample was equally split into 5 portions. Each portion of the sample was calcined in air for 6 hrs at 400, 450, 500, 538 and 600° C., respectively. The calcining furnace was ramped at rate of 2.5° C./min. During the calcination, the air flow was adjusted at 5 volume/volume of solid/minute. The sorbent contains 16 wt % K₂O/Al₂O₃ as potassium loading.

### Example 2

### Extrusions of Versal 300 Al₂O₃

500 g of Versal 300 Al₂O₃ powders was placed in muller, and the mulling of Al₂O₃ powders took about 40 minutes. The extrusion dough targeted solid percentage was 44.25%. The mixture dough was extruded into 1/16″ quadrille extrudates with 1 inch Diamond America Extruder. After the extrusion, the extrudates were spread into thin layers in the sample trays. The extrudates were dried 16 hours in air at 120° C. Then, the calcinations of Al₂O₃ extrudates were carried out in air for 6 hrs at 120, 200, 230, 300, 350 and 538° C., respectively. The calcining furnace was ramped at rate of 2.5° C./min. During the calcination, the air flow was adjusted at 5 volume/volume of solid/minute.

### Example 3

### Preparation of 9.9% K₂O+6.5% Na₂O/Al₂O₃

The extrudates made by extrusion of Versal 300 alumina calcined at various temperatures were used as supports for the depositions of sodium and potassium carbonates.

The aqueous solution containing sodium and potassium carbonates was prepared by dissolving Na₂CO₃ and K₂CO₃ in distilled H₂O. The sorbent was prepared by incipient wetness. 17.275 g of potassium carbonate and 13.248 g of sodium carbonate were dissolved in 60.0 g of distilled H₂O. The total solution volume of Na₂CO₃ and K₂CO₃ adjusted with distilled water was 82.7 ml. 100.0 g of Versal alumina extrudates were impregnated with the solution by incipient wetness. The sample was dried in air at 120° C. for 16 hours and calcined in air at 538° C. for 6 hours. The furnace was ramped at rate of 2.5° C./min. During the calcination, the air flow was adjusted at 5 volume/volume of solid/minute. The sorbent contains 9.9% K₂O and 6.5% Na₂O as K and Na loadings.

### Example 4

### CO₂ Sorption/Steam Displacement Fixed Bed Testing

Simulated flue gas during fixed bed testing contained 13.4% CO₂ and 14.9% H₂O balanced with N2. The fixed bed volume is 100 cc. With the simulated natural gas conditions the flue gas space velocity during screening conditions was 10.56 SCCM/g for 9 minutes and steam regeneration space velocity was 3.74 SCCM/g for 9 minutes. The temperature during adsorption was about 140° C., increasing to approximately 153° C. during sorbent regeneration.

In the single fixed bed, all flow controllers were calibrated to obtain high accuracy in gas flow rates. Whenever a gas is not in use, the flow controller is completely shut to prevent any gas leakage. During adsorption cycle, N₂ and CO₂ are mixed with steam provided by syringe pump. The feed enters the bed by down-flow through a 3-way valve and exits through another 3-way valve. The outlet gas/steam moves through a chiller, and the steam is condensed, collected and measured by an online scale. N₂ and CO₂ gases pass the chiller and exit to a ZRE CO₂ analyzer which measures the breakthrough CO₂ concentration. During regeneration cycle, both the 3-way valves are switched to allow steam controlled by a syringe pump to enter the bed by up-flow and exit via a different path toward a second chiller. The steam is condensed and collected by online scale for measurement of water out in regeneration. CO₂ passes the chiller and is diluted with N₂ before entering the ZRE CO₂ analyzer which detects the desorbed CO₂ concentration. Both syringe pumps are continuously running through a 3-way valve which directs the steam either through the bed or to a by-pass line. The downstream N₂ is also used to flush out the condensed water in the exit line at the end of each cycle.

### RESULTS AND DISCUSSION

CO₂ uptakes were measured by a TGA on 16% K₂O/Al₂O₃ sorbents. The gas stream used for CO₂ TGA measurement was 5.7% CO₂ balanced with nitrogen. TGA measurements of CO₂ sorption were carried out at150° C. FIG. 2 shows the sorbent calcination temperature effects on CO₂ sorption capacity. 16% K₂O/Al₂O₃ was prepared by impregnation of K acetate onto alumina support. After drying at 120° C., the samples were calcined in air at 400, 450, 500, 538 and 600° C., respectively, for 6 hrs. The thermal calcination up to 538° C. promotes K dispersion on alumina support surface, which improves CO₂ sorption capacity. Higher temperature calcination apparently drives the formation of potassium aluminate KAlO₂, which reduces CO₂ sorption capacity. The optimum calcination temperature determined by TGA CO₂ sorption measurements is 538° C., which balances K₂O dispersion and the formation of KAlO₂.

The alumina extrudates made by extrusion of Versal 300 boehmite were calcined at various temperatures, which were used as supports for the depositions of sodium and potassium carbonates. The calcinations of alumina extrudates were carried out in air for 6 hrs at 120, 200, 230, 300, 350 and 538° C., respectively. It can be seen from Table 1 that alumina extrudates crush strength increases as drying/calcining temperature rises. Higher calcination temperature can condense alumina extrudates more through removals of hydroxyl groups, or dehydration. It is consistent with Al₂O₃ extrudate solid content increases as calcinations temperature increases.

TABLE 1
Physical Properties of Alumina Extrudates

| Versal 300 Al₂O₃ | Al₂O₃ Extrudate Solid | Extrudate Crush |
|---|---|---|
| Extrudates Calcined at | Content at 525° C. | Strength Vankel |
| Various Temperatures | for 15 min | Average (lbs/in |
| 120° C. | 80.7% | 77 |
| 200° C. | 83.6% | 100 |
| 250° C. | 85.4% | 114 |
| 300° C. | 88.0% | 154 |
| 350° C. | 93.9% | 134 |
| 538° C. | N/A* | 204 |

*The sample prep calcination temperature of 538° C. is higher than the solid content measurement temperature of 525° C.

TABLE 2
CCS Performance of 9.9% K₂O + 6.5% Na₂O/Al₂O₃

| Al₂O₃ Calcined | Sorbent | CO₂ Sorption | H₂O/CO₂ |
|---|---|---|---|
| Temp. ° C. | Density | Loading, wt % | Molar Ratio |
| 120° C. | 0.62 | 1.22 | 3.81 |
| 200° C. | 0.52 | 1.07 | 3.72 |
| 250° C. | 0.55 | 1.05 | 3.77 |
| 300° C. | 0.53 | 1.18 | 3.93 |
| 350° C. | 0.53 | 1.18 | 3.77 |
| 538° C. | 0.53 | 1.03 | 3.29 |

Table 2 lists the sorbents of K and Na carbonates supported on alumina extrudates which were calcined at various temperatures. Hydroxyl groups of the alumina act as anchoring points for alkali metal carbonate dispersions. The hydroxyl group concentrations of alumina support can be preserved with low temperature calcinations, which can improve Na and K carbonates dispersions and increase CO₂ sorption capacity. The Table 2 shows that when alumina extrudates which were calcined between 120˜350° C., the CO₂ sorption capacities of the sorbents are higher than the sample made with alumina calcined at 538° C. However, too low temperature calcination can also results in weak crush strength alumina extrudates. The appropriate temperatures for alumina supports calcinations are around 250˜350° C. The temperatures of boehmite (γ-AlOOH.H₂O) converting to gamma alumina (γ-Al₂O₃) are between 500 to 850° C. Hydroxyl group concentrations on γ-AlOOH is inherently higher than those on γ-Al₂O₃. High Hydroxyl group concentrations increase alkali metal carbonate dispersions on alumina surfaces. Consequently, it increases CO₂ sorption capacity of the sorbent.

Table 3 summarizes the CO₂/H₂O displacement desorption performances of several CO₂ sorbents developed and incorporated herein.

TABLE 3
Summary of CO₂ Sorbent Development

| Sorbent | | | | | |
|---|---|---|---|---|---|
| Impregnating | Sorbent A | Sorbent B | Sorbent C | Sorbent D | Sorbent E |
| alkali metal | 12% Na₂O | 15.85% K₂O | 9.9% K₂O + 6.5% Na₂O | 5.4% K₂O + 3.5% Na₂O | 5.4% K₂O + 3.5% Na₂O |
| Support | Al₂O₃ | Al₂O₃ | Al₂O | 10% K₂O/Al₂O₃ | 10% K₂O/Al₂O₃ |
| CO₂ wt % | 0.56 | 0.81 | 1.03 | 1.07 | 1.14 |
| loading | | | | | |
| Molar ratio of | 6.60 | 5.50 | 4.31 | 3.66 | 3.94 |
| H₂O/CO₂ | | | | | |
| Density (g/ml) | 0.60 | 0.48 | 0.53 | 0.62 | 0.7 |

Sorbent A was prepared by extrusion of Na₂CO₃ with Versal-700 Al₂O₃. CO₂ sorption loading was 0.56 wt %, with molar ratio of H₂O/CO₂ of 6.60.

Sorbent B was prepared by impregnation of K₂CO₃ solution onto alumina support. Higher CO₂ sorption capacity was due to higher dispersion of potassium carbonate on Al₂O₃. Formation of poison phase of potassium aluminate carbonate hydrate gradually reduced CO₂ capacity on stream.

Sorbent C was mixed Na+K sorbents, according to co-pending provisional application filed on the same date and titled MIXED METAL SORBENTS FOR CO₂/H₂O DISPLACEMENT DESORPTION, herein incorporated by reference in its entirety as if fully set forth below. Addition of Na carbonate was to interrupt the crystallization of the poison phase K aluminate carbonate hydrate. The similar counterpart phase with Na cations does not exist.

Better sorbent performance compared to 2nd generation sorbent, higher CO₂ sorption capacity of 1.03 wt % and lower H₂O/CO₂ ratio of 4.31.

Sorbent D was prepared by extrusions of K₂CO₃ with alumina to preform denser phase of pseudo KAlO₂, according to same date and titled HIGH PERFORMANCE CO₂/H₂O DISPLACEMENT DESORPTION SORBENTS AND METHODS OF MAKING SAME, herein incorporated by reference in its entirety as if fully set forth below. After extrusion, the 10% K₂O/Al₂O₃ was impregnated with K₂CO₃ and Na₂CO₃ solutions, according to co-pending provisional application filed on the same date and titled MIXED METAL SORBENTS FOR CO_{2/}H₂O DISPLACEMENT DESORPTION. Stable and high CO₂ loading of 1.07 wt % and much low H₂O/CO₂ ratio of 3.66 were observed. Also the density of the sorbent was increased to 0.62.

Sorbent E was prepared by extrusions of K₂CO₃ with alumina to preform denser phase support of KAlO₂, according to this disclosure. After extrusion, the support of 10% K₂O/Al₂O₃ was only dried at 250° F. in air before it use as support for Na and K carbonates deposition. Without calcination, more hydroxyl groups on the supports were preserved, which can act as anchoring points for Na and K carbonates dispersions. This leads to higher CO₂ loading of 1.14 wt %. Also the density of the sorbent was further increased to 0.70 g/ml, which indicates that CO₂ sorption loading per volume of sorbent increased.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based can be readily utilized as a basis for the design of other structures, methods, and systems for carrying out the several purposes of the embodiments and claims presented in this application. It is important, therefore, that the claims be regarded as including such equivalent constructions.

We claim:

1. A method for preparing a CCS sorbent, comprising
preparing a support by
mixing an aluminum compound to form a dough
extruding the dough to form an extrudate,
drying the extrudate to form the support; and
calcining the support at about 120 to about 500° C. for at least 1 hour;
impregnating a alkali metal salt into the support;
drying the impregnated support; and
calcining the impregnated support at about 400 to about 550° C. for at least 3 hours to create the sorbent.

2. The method of claim 1, wherein the extrudate is dried at between about 90 and about 175° C.

3. The method of claim 1, wherein the extrudate is calcined between about 250 to about 400° C.

4. The method of claim 1, wherein the extrudate is calcined between about 250 to about 350° C.

5. The method of claim 1, wherein the aluminum compound comprises aluminum oxide, aluminum oxide hydroxide, aluminum hydroxide, boehmite, or pseudoboehmite.

6. The method of claim 1, wherein the aluminum compound comprises an aluminum oxide hydroxide, boehmite or pseudoboehmite.

7. The method of claim 1, wherein the impregnating alkali metal salt comprises a potassium salt, a sodium salt, or a lithium salt.

8. The method of claim 1, wherein the impregnating alkali metal salt comprising potassium and sodium.

9. The method of claim 1, wherein the impregnating alkali metal salt is greater than about 5 weight % of the sorbent as M₂O.

10. The method of claim 1, wherein the impregnating alkali metal salt is greater than about 8 weight % of the sorbent as M₂O.

11. The method of claim 1, wherein the mixing of the aluminum compound further includes an alkali metal salt in a mixture with the aluminum compound to form the dough.

12. The method of claim 13, wherein the alkali metal salt added to the mixture comprises a potassium salt, a sodium salt, or both a potassium salt and a sodium salt.

13. A method for preparing a CCS sorbent, comprising
Calcining a dried aluminum compound extrudate at about 125 to about 500° C. for at least 1 hour to create a support, and
calcining the support at about 400 to about 550° C. for at least 3 hours after impregnating with an alkali metal salt.

14. The method of claim 13, wherein the extrudate is calcined between about 250 to about 400° C.

15. The method of claim 13, wherein the extrudate is calcined between about 250 to about 350° C.

16. The method of claim 13, the support is calcined between about 450 and 550° C.

17. The method of claim 13, wherein the aluminum compound comprises aluminum oxide, aluminum oxide hydroxide, aluminum hydroxide, boehmite, or pseudoboehmite.

18. The method of claim 13, wherein the aluminum compound comprises aluminum oxide hydroxide, boehmite or pseudoboehmite.

19. The method of claim 13, wherein the impregnating alkali metal salt comprises a potassium salt, a sodium salt, or a lithium salt.

20. The method of claim 13, wherein the impregnating alkali metal salt comprising potassium and sodium.

21. The method of claim 13, wherein the impregnating alkali metal salt is about greater than about 5 weight % of the sorbent as M₂O.

22. The method of claim 13, wherein the impregnating alkali metal salt is about greater than about 8 weight % of the sorbent as M₂O.

23. The method of claim 13, wherein the mixing of the aluminum compound further an alkali metal salt in a mixture with the aluminum compound to form the dough.

24. The method of claim 23, wherein the alkali metal salt added to the mixture comprises a potassium salt, a sodium salt, or both a potassium salt and a sodium salt.
